(19) United States
(12) Patent Application Publication
(10) Pub. No.: US 2017/0136727 A1
(43) Pub. Date: May 18, 2017

(54) CONDUCTIVE FILM LAMINATE, CONDUCTOR, MANUFACTURING METHOD OF CONDUCTOR

(71) Applicant: FUJIFILM Corporation, Tokyo (JP)

(72) Inventor: Haruhiko MIYAMOTO, Ashigara-kami-gun (JP)

(73) Assignee: FUJIFILM Corporation, Tokyo (JP)

(21) Appl. No.: 15/420,180

(22) Filed: Jan. 31, 2017

Related U.S. Application Data
(63) Continuation of application No. PCT/JP2015/073082, filed on Aug. 18, 2015.

(30) Foreign Application Priority Data
Sep. 4, 2014 (JP) 2014-180016

(51) Int. Cl. B32B 3/26; H01B 5/14; B32B 37/14; B32B 7/02; G06F 3/041

(52) U.S. Cl. CPC B32B 3/266; B32B 7/02; G06F 3/041; B32B 37/14; H01B 5/14; B32B 2307/202; B32B 2457/208; G06F 2203/04102; G06F 2203/04103; G06F 2203/04112

(57) ABSTRACT

A conductive film laminate includes: an insulating support having a flat plate shape; and a conductive film which is bonded onto a surface of the support with an adhesive, in which the conductive film includes an insulating substrate having flexibility and a conductive layer which is disposed on a surface of the insulating substrate, and the insulating substrate includes at least one opening formed by cutout of a portion where forming strain is concentrated, when forming the conductor, and the opening is covered with the support.

### CROSS-REFERENCE TO RELATED APPLICATIONS

This application is a continuation of PCT International Application No. PCT/JP2015/073082 filed on Aug. 18, 2015, which claims priority under 35 U.S.C. §119(a) to Japanese Patent Application No. 2014-180016 filed on Sep. 4, 2014. Each of the above applications is hereby expressly incorporated by reference, in its entirety, into the present application.

### BACKGROUND OF THE INVENTION

1. Field of the Invention

The present invention relates to a conductive film laminate, and particularly relates to a conductive film laminate for forming a three-dimensional conductor.

The invention also relates to a conductor using a conductive film laminate and a manufacturing method of a conductor.

2. Description of the Related Art

In recent years, touch panels which are used in combination with display devices such as liquid crystal display devices and perform an input operation to electronic device by coming into contact with a screen, in various electronic devices such as portable information devices have come into wide use.

It is required to provide thin touch panels having a three-dimensional shape, while the improvement of portability and operability of electronic devices is required. Therefore, the development of a conductive film in which detection electrodes are formed on a flexible and transparent insulating substrate has proceeded.

JP2013-257796A, for example, discloses a method of manufacturing a touch panel having a curved touch surface, including deforming a conductive film to have a three-dimensional shape, and integrating the conductive film with a transparent insulating support.

### SUMMARY OF THE INVENTION

When manufacturing such a three-dimensional touch panel, a method of deforming both of a conductive film and a support to have a three-dimensional shape and bonding these to each other is used, but, it is difficult to obtain a touch panel having high quality due to errors in deformation shapes of the conductive film and the support and position deviation at the time of the bonding, and the manufacturing method is complicated.

In addition, a method of manufacturing a three-dimensional touch panel, including setting a conductive film in a die and performing injection forming to form a support is used, but, it is difficult to form a thin support by using the injection forming.

Then, a method of adhering a conductive film to a support having a flat plate shape and collectively forming the conductive film and the support into a three-dimensional shape has been considered (JP2013-257796A).

However, it is found that bonding strength is decreased and the conductive film is peeled off from the support, in a part having great forming strain, particularly, in a high temperature and high humidity environment.

In addition, it is found that, other than in touch panels, also in three-dimensional heating elements and three-dimensional electromagnetic shielding materials for protecting electronic devices from noise, a conductive film is peeled off from a support, in a case of collectively forming the conductive film and the support into a three-dimensional shape.

The invention is made to address the aforementioned problems of the related art and an object thereof is to provide a conductive film laminate capable of preventing peeling of a support and a conductive film, even when the support and conductive film are formed into a three-dimensional shape.

Another object of the invention is to provide a conductor obtained by using the conductive film laminate.

Still another object of the invention is to provide a manufacturing method of a conductor using the conductive film laminate.

According to the invention, there is provided a conductive film laminate for forming a three-dimensional conductor comprising: an insulating support having a flat plate shape; and a conductive film which is bonded onto a surface of the support with an adhesive, in which the conductive film includes an insulating substrate having flexibility and a conductive layer which is disposed on a surface of the insulating substrate, and the insulating substrate includes at least one opening formed by cutout of a portion where forming strain is concentrated, when forming the conductor, and the opening is covered with the support.

When forming the conductor, in a case where a formed portion which is formed into a three-dimensional shape and a flange portion which is on a periphery of the formed portion are formed, and the formed portion includes an upper surface and at least one side surface connected to the upper surface, the opening of the conductive film may be disposed so as to include a part of a boundary portion between the upper surface and the side surface of the formed portion.

In this case, the formed portion may include the upper surface which is polygonal and a plurality of the side surfaces, the conductive film may include a plurality of the openings corresponding to a plurality of apexes of the upper surface, and each opening may be disposed so as to include the apex corresponding to the upper surface and a pair of the side surfaces which intersect with each other at the corresponding apex.

The formed portion may include the upper surface which is circular or elliptical and one side surface, the conductive film may include a plurality of the openings corresponding to boundary lines on a plurality of portions of an annular boundary portion between the upper surface and the side surface, and each opening may be disposed so as to include the boundary line corresponding to the upper surface and the side surface.

The opening may be formed of a penetration hole which penetrates through the conductive film.

The forming may be a bulging process.

When forming the conductor, the formed portion which is formed into a three-dimensional shape and a flange portion which is on a periphery of the formed portion may be formed, and the formed portion may include an upper surface and at least one side surface connected to the upper surface, and the opening of the conductive film may be disposed so as to include a part of a boundary portion between the side surface of the formed portion and the flange portion.

In this case, the formed portion may include the upper surface which is polygonal and a plurality of the side surfaces, the conductive film may include the plurality of openings corresponding to a plurality of intersection points where a pair of the side surfaces of the formed portion adjacent to each other and the flange portion intersect with each other, and each opening may be disposed so as to include the pair of side surfaces of the formed portion and the flange portion which intersect with each other in the corresponding intersection point.

The formed portion may include the upper surface which is circular or elliptical and one side surface, the conductive film may include a plurality of the openings corresponding to boundary lines on a plurality of portions of an annular boundary portion between the side surface and the flange portion, and each opening may be disposed so as to include the boundary line corresponding to the side surface of the formed portion and the flange portion.

The opening may be formed of a cut-out.

The forming may be a deep drawing process.

The support and the insulating substrate may have transparency, the conductive layer may include a plurality of detection electrodes which are disposed on at least one surface of the insulating substrate and has a mesh pattern formed of thin metal wires, and the conductive film laminate may be used in a touch panel.

According to the invention, there is provided a conductor in which the conductive film laminate described above is formed to have a three-dimensional shape.

According to the invention, there is provided a manufacturing method of a conductor comprising: performing the press forming of the conductive film laminate described above into a three-dimensional shape; and removing an unnecessary portion of the press-formed conductive film laminate.

The manufacturing method may further comprise: performing the bulging of the conductive film laminate described above into a three-dimensional shape; and removing the flange portion of the conductive film laminate subjected to the bulging as an unnecessary portion. The manufacturing method may further comprise: performing the deep drawing of the conductive film laminate described above into a three-dimensional shape; and removing the flange portion of the conductive film laminate subjected to the deep drawing as an unnecessary portion.

According to the invention, since the insulating substrate of the conductive film bonded onto the surface of the support includes at least one opening formed by cutout of the portion where the forming strain is concentrated when forming a conductor, and the opening is covered with the support, it is possible to prevent the peeling of the support and the conductive film, even when the forming into a three-dimensional shape is performed.

### BRIEF DESCRIPTION OF THE DRAWINGS

FIG. 1 is a perspective view showing a conductive film laminate for a touch panel according to Embodiment 1 of the invention.

FIG. 2 is a partial cross section showing the conductive film laminate for a touch panel of Embodiment 1.

FIG. 3 is a plan view showing a conductive film of the conductive film laminate for a touch panel of Embodiment 1.

FIG. 4 is a partial plan view showing a detection electrode of the conductive film.

FIGS. 5A and 5B are cross sections for explaining a bulging process.

FIG. 6 is a perspective view showing the conductive film laminate for a touch panel of Embodiment 1 subjected to the bulging process to have a square tube shape.

FIG. 7 is a perspective view showing a touch panel formed from the conductive film laminate for a touch panel of Embodiment 1.

FIG. 8 is a perspective view showing a conductive film laminate for a touch panel according to Embodiment 2.

FIG. 9 is a perspective view showing the conductive film laminate for a touch panel of Embodiment 2 subjected to a deep drawing process to have a square tube shape.

FIGS. 10A and 10B are cross sections for explaining the deep drawing process.

FIG. 11 is a perspective view showing a touch panel formed from the conductive film laminate for a touch panel of Embodiment 2.

FIG. 12 is a perspective view showing a conductive film laminate for a touch panel according to Embodiment 3.

FIG. 13 is a perspective view showing the conductive film laminate for a touch panel according to Embodiment 3 subjected to a bulging process to have a cylindrical shape.

FIG. 14 is a perspective view showing a touch panel formed from the conductive film laminate for a touch panel of Embodiment 3.

FIG. 15 is a perspective view showing a conductive film laminate for a touch panel according to Embodiment 4.

FIG. 16 is a perspective view showing the conductive film laminate for a touch panel according to Embodiment 4 subjected to a deep drawing process to have a cylindrical shape.

FIG. 17 is a perspective view showing a touch panel formed from the conductive film laminate for a touch panel of Embodiment 4.

FIG. 18 is a view showing parts of the conductive film laminate for a touch panel press-formed to have a square tube shape, where film thicknesses are measured.

FIG. 19 is a graph showing film thickness distributions of the conductive film laminate for a touch panel subjected to the bulging process and the conductive film laminate for a touch panel subjected to the deep drawing process.

FIG. 20 is a view showing parts of the conductive film, where openings are formed, when performing the press-forming to set a square tube shape.

FIG. 21 is a view showing parts of the conductive film, where openings are fair red, when performing the press-forming to set a cylindrical shape.

### DESCRIPTION OF THE PREFERRED EMBODIMENTS

A conductive film laminate according to the invention can be used in a touch panel in which a plurality of detection electrodes are formed on a surface of a transparent support, but the conductive film laminate can also be used in conductors such as heating elements for generating heat in which a conductive film is bonded onto a surface of a support and electromagnetic shielding materials for shielding electromagnetic waves in which a conductive film is bonded onto a surface of a support.

Here, the following embodiments will be described using a touch panel as an example.

### Embodiment 1

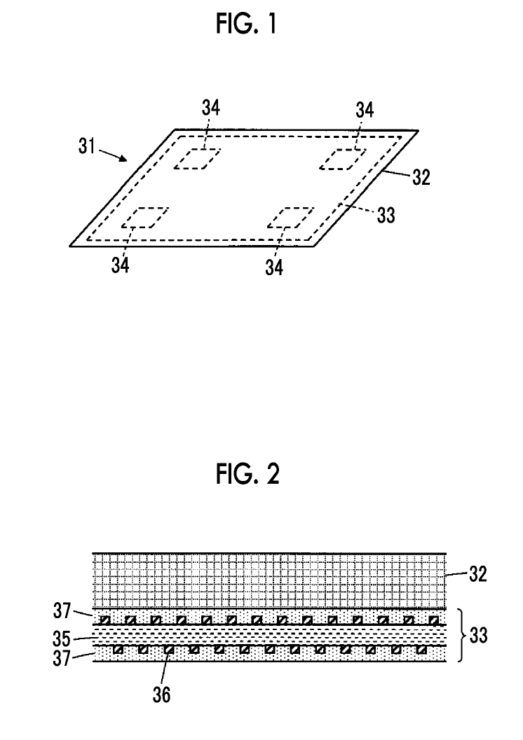

FIG. 1 shows a configuration of a conductive film laminate for a touch panel 31 according to Embodiment 1. The conductive film laminate for a touch panel 31 is an element for manufacturing a touch panel having a square tube shape using a bulging process, and a transparent conductive film 33 is bonded onto a surface of a transparent insulating support 32 having a flat plate shape with an adhesive. The conductive film 33 has a rectangular flat plate shape and openings 34 formed of penetration holes are formed at positions in the vicinity of four corners of the rectangle. When the conductive film laminate for a touch panel 31 is formed to have a square tube shape, the openings 34 are formed at positions respectively including four apexes of the upper surface of the square tube.

As shown in FIG. 2, in the conductive film 33, conductive members 36 are respectively formed on both surfaces of a flexible and transparent rectangular insulating substrate 35 and transparent protective layers 37 are formed on both surfaces of the insulating substrate 35 so as to cover the conductive member 36.

The openings 34 are formed on parts of the insulating substrate 35 where the conductive members 36 are not formed and are respectively covered with the support 32. Here, the expression “being covered” means a state where 60% or more of the opening area of the opening 34 is covered before or after forming.

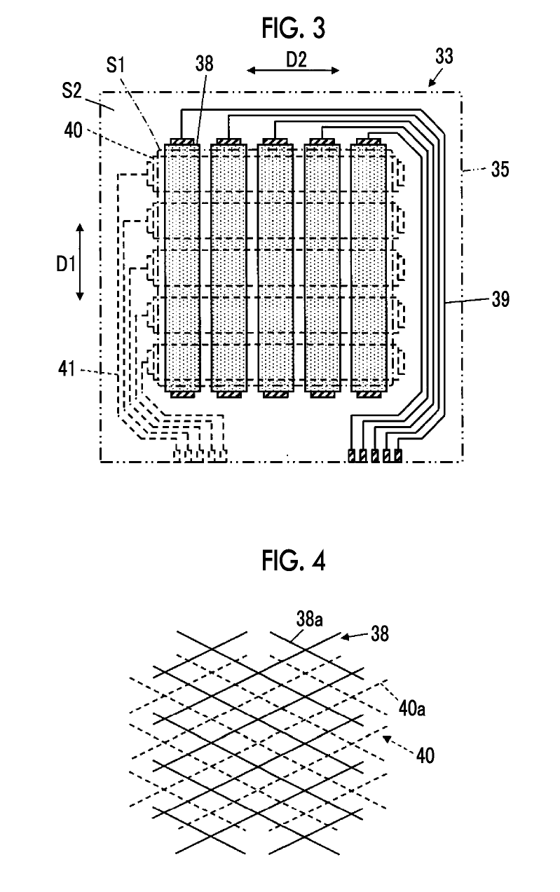

As shown in FIG. 3, the conductive film 33 is partitioned into a sensing area S1, and a peripheral area S2 which is on the outer side of the sensing area S1. On the front surface of the insulating substrate 35, a plurality of first detection electrodes 38 which are respectively extended along a first direction D1 and disposed in parallel with a second direction D2 orthogonal to the first direction D1 are formed in the sensing area S1, and a plurality of first peripheral wirings 39 connected to the plurality of first detection electrodes 38 are arranged to be adjacent to each other in the peripheral area S2.

In the same manner as described above, on the rear surface of the insulating substrate 35, a plurality of second detection electrodes 40 which are respectively extended along the second direction D2 and disposed in parallel with the first direction D1 are formed in the sensing area S1, and a plurality of second peripheral wirings 41 connected to the plurality of second detection electrodes 40 are arranged to be adjacent to each other in the peripheral area S2.

As shown in FIG. 4, the first detection electrode 38 disposed on the front surface of the insulating substrate 35 is formed with a mesh pattern formed of thin metal wires 38a and the second detection electrode 40 disposed on the rear surface of the insulating substrate 35 is formed with a mesh pattern formed of thin metal wires 40a.

The conductive film 33 is manufactured by forming the conductive members 36 including the first detection electrodes 38 and the first peripheral wirings 39 on the front surface of the insulating substrate 35, forming the conductive members 36 including the second detection electrodes 40 and the second peripheral wirings 41 on the rear surface of the insulating substrate 35, and forming transparent protective layers 37 on both surfaces of the insulating substrate 35 so as to cover these conductive members 36.

A formation method of the conductive members 36 is not particularly limited. As disclosed in paragraphs “0067” to “0083” of JP2012-185813A, for example, the conductive members 36 can be formed by exposing a photosensitive material including an emulsion layer containing photosensitive silver halide salt to light to perform a development process.

The conductive members 36 can also be formed by respectively forming metal foils on the front surface and the rear surface of the insulating substrate 35 and printing a resist on each metal foil in a pattern shape or exposing and developing a resist applied to the entire surface for patterning, and etching the metal of openings. In addition, a method of printing a paste containing fine particles of a material configuring the conductive members 36 on the front surface and the rear surface of the insulating substrate 35 and performing metal plating with respect to the paste, a method using an ink jet method of using an ink including fine particles of a material configuring the conductive members 36, a method of forming an ink including fine particles of a material configuring the conductive members 36 by screen printing, a method of forming a resin including grooves of the insulating substrate 35 and applying conductive ink onto the grooves, or a micro-contact print patterning method can be used.

Here, as an example, a method of manufacturing a conductive film for a touch panel by exposing a photosensitive material including an emulsion layer containing photosensitive silver halide salt to light to perform a development process will be described.

(Preparation of Silver Halide Emulsion)

Amounts of a 2 solution and a 3 solution below corresponding to 90% were added to a 1 solution below held at 38° C. and pH of 4.5 for 20 minutes while being stirring, and nuclear particles having a diameter of 0.16 μm were formed. Then, a 4 solution and a 5 solution below were added thereto for 8 minutes, and the amounts of the remaining 10% of the 2 solution and the 3 solution below were added thereto for 2 minutes, and the particles were caused to grow to have a diameter of 0.21 μm. 0.15 g of potassium iodide was added thereto, aging was performed for 5 minutes, and particle formation was finished.

1 solution:
Water: 750 ml
Gelatin: 9 g
Sodium chloride: 3 g
1,3-dimethyl-2-thione: 20 mg
Sodium benzenethiosulfonate: 10 mg
Citric acid: 0.7 g

2 solution:
Water: 300 ml
Silver nitrate: 150 g

3 solution:
Water: 300 ml
Sodium chloride: 38 g
Potassium bromide: 32 g
Potassium hexachloroiridate (III) (0.005% of KCl and 20% of aqueous solution): 8 ml
Ammonium hexachlorinated rhodiumate (0.001% of NaCl and 20% of aqueous solution): 10 ml

4 solution:
Water: 100 ml
Silver nitrate: 50 g

5 solution:
Water: 100 ml
Sodium chloride: 13 g
Potassium bromide: 11 g
Yellow prussiate of potash: 5 mg

After that, washing was performed using a flocculation method according to the usual method. Specifically, the temperature was decreased to 35° C. and pH was decreased using sulfuric acid until silver halide is precipitated (pH was in a range of 3.6±0.2). Then, approximately 3 liters of the supernatant was removed (first washing). After adding 3 liters of distilled water, sulfuric acid was added until silver halide is precipitated. 3 liters of the supernatant was removed again (second washing). The same operation as the second washing was further repeated one more time (third washing) and a washing and desalting step was finished. The pH of the emulsion after washing and desalting was adjusted to 6.4 and the pAg thereof was adjusted to 7.5, 3.9 g of gelatin, 10 mg of sodium benzenethiosulfonate, 3 mg of sodium benzenethiosulfinate, 15 mg of sodium thiosulfate, and 10 mg of chloroauric acid were added thereto, chemosensitization was performed so as to obtain optimal sensitivity at 55° C., 100 mg of 1,3,3a,7-tetraazaindene as a stabilizer and 100 mg of PROXEL (product name, manufactured by ICI Co., Ltd.) as a preservative were added thereto. The emulsion finally obtained was a iodide salt silver bromide cubic grain emulsion containing 0.08 mol % of silver iodide, in which a proportion of silver chlorobromide was set so that a proportion of silver chloride is 70 mol % and a proportion of silver bromide is 30 mol %, an average particle diameter is 0.22 μm, and a coefficient of variation is 9%.

(Preparation of Composition for Forming Photosensitive Layer)

1.2×10⁻⁴ mol/mol Ag of 1,3,3a,7-tetraazaindene, 1.2×10⁻² mol/mol Ag of hydroquinone, 3.0×10⁻⁴ mol/mol Ag of citric acid, and 0.90 mol/mol Ag of 2,4-dichloro-6-hydroxy-1,3,5-triazine sodium salt were added to the emulsion described above, the pH of the coating solution was adjusted to 5.6 using citric acid, and a composition for forming a photosensitive layer was obtained.

(Photosensitive Layer Formation Step)

After performing corona discharge treatment with respect to an insulating substrate, a gelatin layer having a thickness of 0.1 μm as an undercoat was provided on both surfaces of the insulating substrate, and an antihalation layer containing a dye which has an optical density of approximately 1.0 and is decolored due to alkali of a developer was further provided on the undercoat. The composition for forming a photosensitive layer was applied onto the antihalation layer, a gelatin layer having a thickness of 0.15 μm was further provided, and the insulating substrate including photosensitive layers formed on both surfaces thereof was obtained. The insulating substrate including photosensitive layers formed on both surfaces thereof is set as a film A. Regarding the photosensitive layers formed, an amount of silver was 6.0 g/m² and an amount of gelatin was 1.0 g/m².

(Exposure and Development Step)

The exposure of both surfaces of the film A was performed using parallel light using a high pressure mercury lamp as a light source through a photo mask corresponding to the electrode pattern of the conductive members 36. After the exposure, the development was performed using a developer below and a fixing process was performed using a fixing solution (product name: N3X-R for CN16X manufactured by Fujifilm Corporation). Then, the insulating substrate was rinsed with pure water and dried, and accordingly, an insulating substrate in which conductive members 36 formed of Ag wires and gelatin layers are formed on both surfaces was obtained. The gelatin layers were formed between the Ag wires. The film obtained was set as a film B.

(Composition of Developer)

The following compounds are included in 1 liter (L) of the developer.

Hydroquinone: 0.037 mol/L

N-methylaminophenol: 0.016 mol/L

Sodium metaborate: 0.140 mol/L

Sodium hydroxide: 0.360 mol/L

Sodium bromide: 0.031 mol/L

Potassium metabisulfite: 0.187 mol/L

(Heating Step)

The film B was placed in a superheated vapor tank at 120° C. for 130 seconds to perform the heating process. The film after the heating process was set as a film C.

(Gelatin Decomposing Process)

The film C was dipped in an aqueous solution of a proteolytic enzyme (BIOPLASE AL-15FG manufactured by Nagase ChemteX Corporation) (concentration of proteolytic enzyme: 0.5% by mass, solution temperature: 40° C.) for 120 seconds. The film C was extracted from the aqueous solution and dipped in warm water (solution temperature: 50° C.) for 120 seconds, and then washed. The film after the gelatin decomposing process was set as a film D. The film D was set as a conductive film for a touch panel.

The conductive film 33 manufactured as described above is bonded onto the surface of the support 32 with a transparent adhesive, and thus, the conductive film laminate for a touch panel 31 is manufactured.

As forming material of the support 32, polycarbonate (PC), a cycloolefin polymer (COP), or an acrylic resin can be used.

Next, a method of manufacturing a touch panel having a square tube shape formed using the conductive film laminate for a touch panel 31 will be described.

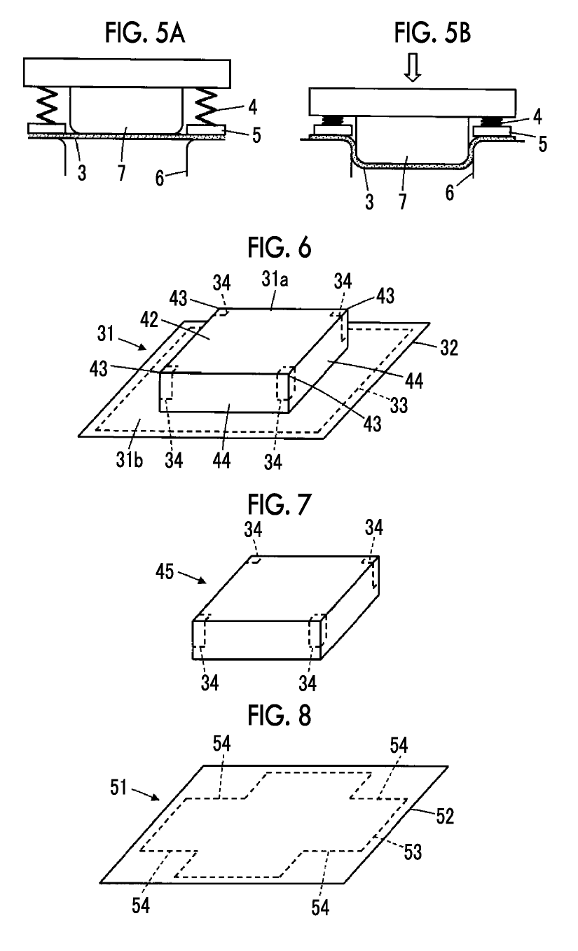

First, by using a press-forming machine shown in FIGS. 5A and 5B, a bulging process of stretching the conductive film laminate for a touch panel 31 is performed by pressing down an upper die 7 in a state where the conductive film laminate for a touch panel 31 is strongly held down between blank holders 5 and lower dies 6 using springs 4. Accordingly, as shown in FIG. 6, a formed portion 31a which is formed into a square tube shape and a flange portion 31b which is on the periphery of the formed portion 31a are formed. At this time, four apexes 43 of an upper surface 42 of a square tube of the formed portion 31a are respectively positioned in the four openings 34 which are formed at positions in the vicinity of four corners of the rectangular conductive film 33.

In these openings 34, the conductive film 33 is not bonded to the support 32 and only the support 32 is present. Accordingly, even when the conductive film laminate for a touch panel 31 is formed to have a square tube shape, the peeling of the conductive film 33 from the support 32 is effectively prevented.

After that, the flange portion 31b is removed from the conductive film laminate for a touch panel 31, and thus, a touch panel 45 having a square tube shape is manufactured, as shown in FIG. 7.

### Embodiment 2

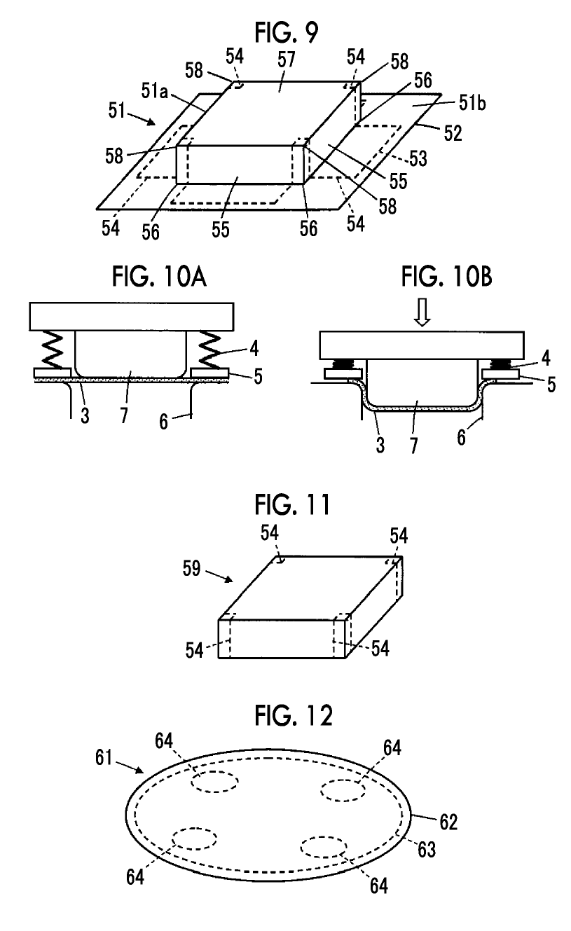

FIG. 8 shows a configuration of a conductive film laminate for a touch panel 51 according to Embodiment 2. The conductive film laminate for a touch panel 51 is an element for manufacturing a touch panel having a square tube shape using a deep drawing process, and a transparent conductive film 53 is bonded onto a surface of a transparent insulating support 52 having a flat plate shape with an adhesive. The conductive film 53 has a flat plate shape in which openings 54 formed of rectangular cut-outs are respectively formed on four corners of the rectangle. When the conductive film laminate for a touch panel 51 is formed to have a square tube shape, as shown in FIG. 9, these openings 54 are formed at positions including four intersection points 56 where a pair of side surfaces 55 adjacent to each other among four side surfaces 55 of the square tube and the flange portion 51b intersect each other.

In the conductive film 53, conductive members such as a plurality of first detection electrodes, a plurality of first peripheral wirings, a plurality of second detection electrodes, and a plurality of second peripheral wirings, as shown in FIG. 3, are formed, in the same manner as in the conductive film 33 of Embodiment 1.

The openings 54 are respectively covered with the support 52. Here, the expression “being covered” means a state where 60% or more of the opening area of the opening 54 is covered before or after forming.

A deep drawing process is performed with respect to the conductive film laminate for a touch panel 51 by pressing down the upper die 7 in a state where the conductive film laminate for a touch panel 51 is lightly held between blank holders 5 and lower dies 6 using springs 4, to an extent as not to generate wrinkles on the peripheral portion, by using a press-forming machine shown in FIGS. 10A and 10B. Accordingly, as shown in FIG. 9, a formed portion 51a which is formed into a square tube shape and a flange portion 51b which is on the periphery of the formed portion 51a are formed.

At this time, the four intersection points 56 where a pair of side surfaces 55 adjacent to each other among four side surfaces 55 of the square tube of the formed portion 51a and the flange portion 51b intersect with each other are respectively positioned in the four openings 54 which are formed at positions close to four corners of the rectangular conductive film 53.

In these openings 54, the conductive film 53 is not bonded to the support 52 and only the support 52 is present. Accordingly, even when the conductive film laminate for a touch panel 51 is formed to have a square tube shape, the peeling of the conductive film 53 from the support 52 is effectively prevented.

In Embodiment 2, areas of the corners of an upper surface 57 of the square tube including the apexes 58 of the upper surface 57 of the square tube are also positioned in the openings 54 of the conductive film 53.

After that, the flange portion 51b is removed from the conductive film laminate for a touch panel 51, and thus, a touch panel 59 having a square tube shape is manufactured, as shown in FIG. 11.

### Embodiment 3

FIG. 12 shows a configuration of a conductive film laminate for a touch panel 61 according to Embodiment 3. The conductive film laminate for a touch panel 61 is an element for manufacturing a touch panel having a cylindrical shape using a bulging process, and a transparent conductive film 63 is bonded onto a surface of a transparent insulating support 62 having a flat plate shape with an adhesive. The conductive film 63 has a circular flat plate shape, and openings 64 formed of penetration holes are respectively formed on four portions in the vicinity of the circumference. When the conductive film laminate for a touch panel 61 is formed to have a cylindrical shape, these openings 64 are formed at positions including a boundary line of four annular boundary portions between an upper surface and a side surface of the cylinder.

In the conductive film 63, conductive members such as a plurality of first detection electrodes, a plurality of first peripheral wirings, a plurality of second detection electrodes, and a plurality of second peripheral wirings, as shown in FIG. 3, are formed, in the same manner as in the conductive film 33 of Embodiment 1.

The openings 64 are respectively covered with the support 62. Here, the expression “being covered” means a state where 60% or more of the opening area of the opening 64 is covered before or after forming.

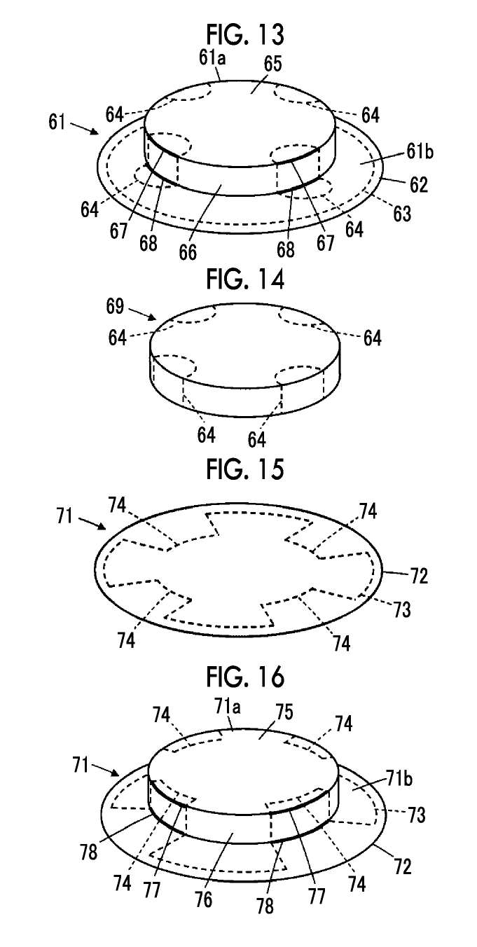

The bulging process is performed with respect to the conductive film laminate for a touch panel 61 by using the press-forming machine shown in FIGS. 5A and 5B. Accordingly, as shown in FIG. 13, a forming portion 61a which is formed into a cylindrical shape and a flange portion 61b which is on the periphery of the formed portion 61a are formed.

At this time, boundary lines 67 of four annular boundary portions between the upper surface 65 and a side surface 66 of the cylinder of the formed portion 61a, and boundary lines 68 of four annular boundary portions between the side surface 66 of the cylinder and the flange portion 61b are respectively positioned in the four openings 64 formed in the conductive film 63.

In these openings 64, the conductive film 63 is not bonded to the support 62 and only the support 62 is present. Accordingly, even when the conductive film laminate for a touch panel 61 is formed to have a cylindrical shape, the peeling of the conductive film 63 from the support 62 is effectively prevented.

After that, the flange portion 61b is removed from the conductive film laminate for a touch panel 61, and thus, a touch panel 69 having a cylindrical shape is manufactured, as shown in FIG. 14.

### Embodiment 4

FIG. 15 shows a configuration of a conductive film laminate for a touch panel 71 according to Embodiment 4. The conductive film laminate for a touch panel 71 is an element for manufacturing a touch panel having a cylindrical shape using a deep drawing process, and a transparent conductive film 73 is bonded onto a surface of a transparent insulating support 72 having a flat plate shape with an adhesive. The conductive film 73 has a circular flat plate shape, and openings 74 formed of cut-outs are respectively formed on four portions in the vicinity of the circumference. When the conductive film laminate for a touch panel 71 is formed to have a cylindrical shape, these openings 74 are formed at positions including a boundary line of four annular boundary portions between a side surface of the cylinder and a flange portion.

In the conductive film 73, conductive members such as a plurality of first detection electrodes, a plurality of first peripheral wirings, a plurality of second detection electrodes, and a plurality of second peripheral wirings, as shown in FIG. 3, are formed, in the same manner as in the conductive film 33 of Embodiment 1.

The openings 74 are respectively covered with the support 72. Here, the expression “being covered” means a state where 60% or more of the opening area of the opening 74 is covered before or after forming.

The deep drawing process is performed with respect to the conductive film laminate for a touch panel 71 by using the press-forming machine shown in FIGS. 10A and 10B. Accordingly, as shown in FIG. 16, a formed portion 71a which is formed into a cylindrical shape and a flange portion 71b which is on the periphery of the formed portion 71a are formed.

At this time, boundary lines 77 of four annular boundary portions between an upper surface 75 and a side surface 76 of the cylinder of the formed portion 71a, and boundary lines 78 of four annular boundary portions between the side surface 76 of the cylinder and the flange portion 71b are respectively positioned in the four openings 74 formed in the conductive film 73.

In these openings 74, the conductive film 73 is not bonded to the support 72 and only the support 72 is present. Accordingly, even when the conductive film laminate for a touch panel 71 is formed to have a cylindrical shape, the peeling of the conductive film 73 from the support 72 is effectively prevented.

In Embodiment 4, the areas of the upper surface 75 of the cylinder adjacent to the boundary lines 78 are also positioned in the openings 74 of the conductive film 73.

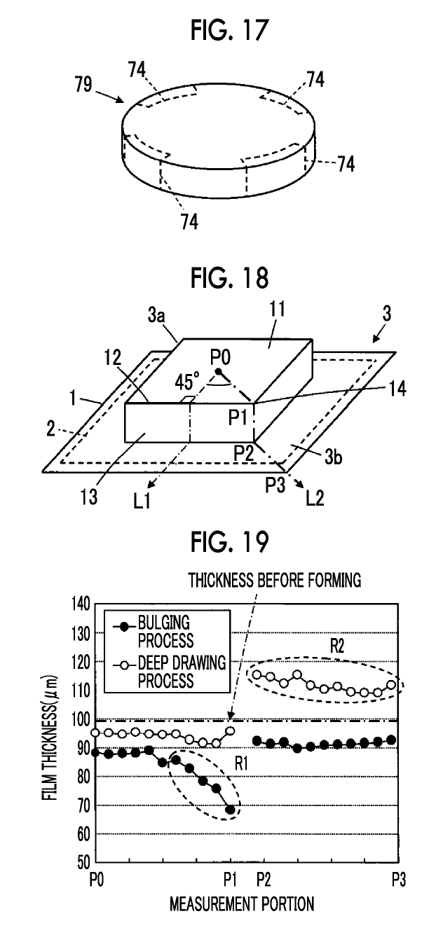

After that, the flange portion 71b is removed from the conductive film laminate for a touch panel 71, and thus, a touch panel 79 having a cylindrical shape is manufactured, as shown in FIG. 17.

In Embodiments 1 and 2, the touch panels 45 and 59 having a square tube shape and including a rectangular upper surface are manufactured, but there is no limitation. In the same manner as described above, a touch panel having a square tube shape including a triangular upper surface or a polygonal upper surface which is a pentagon or more, can also be manufactured.

In Embodiments 3 and 4, the touch panels 69 and 79 having a cylindrical shape are manufactured, but there is no limitation. In the same manner as described above, a touch panel having an elliptical shape can also be manufactured.

Further, touch panels having various three-dimensional shapes can be manufactured, in the same manner as described above.

In addition to the touch panels, three-dimensional conductors such as heating elements or electromagnetic shielding materials can be manufactured, in the same manner as described above.

### EXAMPLES

A conductive film laminate for a touch panel 3 which is manufactured by bonding a transparent conductive film 2 onto a surface of a transparent insulating support 1 with an adhesive was press-formed to have a square tube shape as shown in FIG. 18, and distribution of thicknesses of the conductive film laminate for a touch panel 3 was measured.

Regarding the press forming, both of the bulging process shown in FIGS. 5A and 6B and the deep drawing process shown in FIGS. 10A and 10B were used.

As shown in FIG. 18, the conductive film laminate for a touch panel 3 includes a formed portion 3a which is formed into a square tube shape due to the press forming and a flange portion 3b which is on the periphery of the formed portion 3a. Here, when distribution of thicknesses of the upper surface 11 and a side surface 13 of the square tube of the formed portion 3a and the flange portion 3b was measured, along a measurement line L1 orthogonal to one side 12 of a rectangular upper surface 11 of a square tube, a change in thickness on the measurement line L1 is slight, even in the bulging process or in the deep drawing process, and a portion of the conductive film laminate for a touch panel 3 where forming strain is concentrated is not observed.

With respect to this, when distribution of thicknesses of the upper surface 11 of the square tube of the formed portion 3a and the flange portion 3b was measured from a measurement point P0 to a measurement point P3, along a measurement line L2 which is orthogonal to the side 12 of the upper surface 11 by an angle of 45 degrees and passes through an apex 14 of the upper surface 11, the results shown in FIG. 19 were obtained.

That is, in the conductive film laminate for a touch panel 3 subjected to the bulging process, the thickness of the conductive film laminate for a touch panel 3 is rapidly decreased from the center of the upper surface 11 of the square tube (measurement point P0) towards the apex 14 of the upper surface 11 (measurement point P1), and the flange portion 3b (from measurement point P2 to P3) has substantially a constant thickness. It is found that forming strain is concentrated to a region R1 of a corner of the upper surface 11 of the square tube including the apex 14 of the upper surface 11.

Meanwhile, in the conductive film laminate for a touch panel 3 subjected to the deep drawing process, the upper surface 11 of the square tube (from measurement point P0 to P1) has substantially a constant thickness, but the flange portion 3b (from measurement point P2 to P3) has a value significantly greater than the thickness of the upper surface 11 of the square tube and has a thickness greater than the thickness before the forming. It is found that forming strain is concentrated to a region R2 of the flange portion 3b on the measurement line L2.

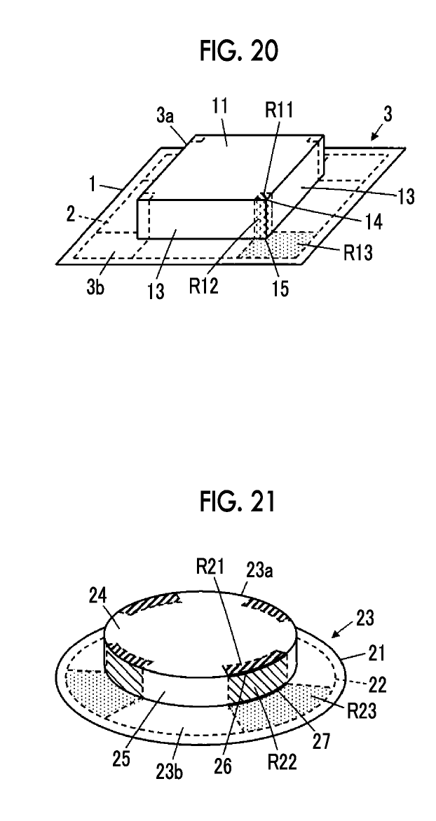

Here, as shown in FIG. 20, a region of a corner of the upper surface 11 of the square tube including the apex 14 of the upper surface 11 of the square tube of the conductive film laminate for a touch panel 3 is referred to as R11, a region of an edge adjacent to the apex 14 of a pair of side surfaces 13 having the apex 14 of the upper surface 11 in common is referred to as R12, and a region of an edge of the flange portion 3b surrounding an intersection point 15 where a pair of side surfaces 13 having the apex 14 of the upper surface 11 in common and the flange portion 3b intersect with each other is referred to as R13.

As shown in Examples 1 to 4 and Comparative Examples 1 to 8 below, a plurality of conductive film laminates for a touch panel in which conductive films including openings formed by cutout of a portion corresponding to at least one region of the regions R11, R12, and R13 were bonded to a support, were manufactured and respectively formed to have a square tube shape using the bulging process and the deep drawing process, and a peeling test for the conductive films from the supports was performed.

### Example 1

A conductive film laminate for a touch panel was manufactured by bonding a conductive film including openings formed by cutout of regions R11 and R12 corresponding to four corners of a square tube, respectively, when performing the forming into a square tube shape, to a support, and was forming to have a square tube shape by using the bulging process.

Here, a biaxial stretching polyethylene terephthalate (PET) film having a thickness of 100 μm was used as the conductive film, polycarbonate (PC) having a thickness 500 μm was used as the support, and a conductive film laminate for a touch panel was manufactured by bonding the conductive film to the support using an optically clear adhesive sheet (OCA) 8172CL manufactured by 3M. This conductive film laminate for a touch panel was formed to have a square tube shape having a size with a length of 70 mm, a width of 70 mm, and a height of 10 mm by using the bulging process.

### Example 2

A conductive film laminate for a touch panel was manufactured in the same manner as in Example 1, except for using a conductive film including openings formed by cutout of regions R11, R12, and R13 corresponding to four corners of a square tube, respectively, when performing the forming into a square tube shape, and the conductive film laminate for a touch panel was formed to have a square tube shape by using the bulging process.

### Example 3

A conductive film laminate for a touch panel was manufactured in the same manner as in Example 1, except for using a conductive film including openings formed by cutout of regions R12 and R13 corresponding, to four corners of a square tube, respectively, when performing the forming into a square tube shape, and the conductive film laminate for a touch panel was formed to have a square tube shape by using the deep drawing process.

### Example 4

A conductive film laminate for a touch panel was manufactured in the same manner as in Example 1, except for using a conductive film including openings formed by cutout of regions R11, R12, and R13 corresponding to four corners of a square tube, respectively, when performing the forming into a square tube shape, and the conductive film laminate for a touch panel was formed to have a square tube shape by using the deep drawing process.

### Comparative Example 1

A conductive film laminate for a touch panel was manufactured in the same manner as in Example 1, except for using a conductive film including openings formed by cutout of regions R11's corresponding to four corners of a square tube, respectively, when performing the forming into a square tube shape, and the conductive film laminate for a touch panel was formed to have a square tube shape by using the bulging process.

### Comparative Example 2

A conductive film laminate for a touch panel was manufactured in the same manner as in Example 1, except for using a conductive film including openings formed by cutout of regions R12's corresponding to four corners of a square tube, respectively, when performing the forming into a square tube shape, and the conductive film laminate for a touch panel was formed to have a square tube shape by using the bulging process.

### Comparative Example 3

A conductive film laminate for a touch panel was manufactured in the same manner as in Example 1, except for using a conductive film including openings formed by cutout of regions R13's corresponding to four corners of a square tube, respectively, when performing the forming into a square tube shape, and the conductive film laminate for a touch panel was formed to have a square tube shape by using the bulging process.

### Comparative Example 4

A conductive film laminate for a touch panel was manufactured in the same manner as in Example 1, except for using a conductive film including openings formed by cutout of regions R12 and R13 corresponding to four corners of a square tube when, respectively, performing the forming into a square tube shape, and the conductive film laminate for a touch panel was formed to have a square tube shape by using the bulging process.

### Comparative Example 5

A conductive film laminate for a touch panel was manufactured in the same manner as in Example 1, except for using a conductive film including openings formed by cutout of regions R11's corresponding to four corners of a square tube, respectively, when performing the forming into a square tube shape, and the conductive film laminate for a touch panel was formed to have a square tube shape by using the deep drawing process.

### Comparative Example 6

A conductive film laminate for a touch panel was manufactured in the same manner as in Example 1, except for using a conductive film including openings formed by cutout of regions R12's corresponding to four corners of a square tube, respectively, when performing the forming into a square tube shape, and the conductive film laminate for a touch panel was formed to have a square tube shape by using the deep drawing process.

### Comparative Example 7

A conductive film laminate for a touch panel was manufactured in the same manner as in Example 1, except for using a conductive film including openings formed by cutout of regions R13's corresponding to four corners of a square tube, respectively, when performing, the forming into a square tube shape, and the conductive film laminate for a touch panel was formed to have a square tube shape by using the deep drawing process.

### Comparative Example 8

A conductive film laminate for a touch panel was manufactured in the same manner as in Example 1, except for using a conductive film including openings formed by cutout of regions R11 and R12 corresponding to four corners of a square tube, respectively, when performing the forming into a square tube shape, and the conductive film laminate for a touch panel was formed to have a square tube shape by using the deep drawing process.

5 samples of the conductive film laminates for a touch panel were manufactured and formed to have a square tube shape in Examples 1 to 4 and Comparative Examples 1 to 8 and the peeling of the support and the conductive films regarding the samples was visually evaluated. The results shown in Table 1 were obtained.

TABLE 1

| | Formed | Forming | | Evaluation |
|---|---|---|---|---|
| | shape | method | Opening | results |
| Example 1 | Square tube | Bulging | R11 + R12 | A |
| Example 2 | Square tube | Bulging | R11 + R12 + R13 | A |
| Example 3 | Square tube | Deep drawing | R12 + R13 | A |
| Example 4 | Square tube | Deep drawing | R11 + R12 + R13 | A |
| Comparative | Square tube | Bulging | R11 | B |
| Example 1 | | | | |
| Comparative | Square tube | Bulging | R12 | B |
| Example 2 | | | | |
| Comparative | Square tube | Bulging | R13 | C |
| Example 3 | | | | |
| Comparative | Square tube | Bulging | R12 + R13 | B |
| Example 4 | | | | |
| Comparative | Square tube | Deep drawing | R11 | C |
| Example 5 | | | | |
| Comparative | Square tube | Deep drawing | R12 | C |
| Example 6 | | | | |
| Comparative | Square tube | Deep drawing | R13 | B |
| Example 7 | | | | |
| Comparative | Square tube | Deep drawing | R11 + R12 | C |
| Example 8 | | | | |

In the evaluation results of Table 1, A indicates that peeling is not recognized in all samples of a test target, B indicates that peeling is recognized in some samples of a test target, and C indicates that peeling is recognized in all samples of a test target.

It was confirmed from Table 1, that the forming strain is concentrated to the regions R11 and R12 in a case of performing the forming into a square tube shape by using the bulging process, and as in Examples 1 and 2, when the conductive film including the openings formed by cutout of portions corresponding to at least both of the regions R11 and R12 is used, the peeling of the support and the conductive film is prevented. Only the regions R11 and R12 may be set as openings as in Example 1, or all of the regions R11, R12, and R13 may be set as openings as in Example 2.

With respect to this, as in Comparative Examples 1 to 4, in a case of using the conductive film including the openings formed by cutout of a portion corresponding to only the region R11, only the region R12, only the region R13, or the regions R12 and R13 was used, peeling was recognized in some samples or all of the samples of the test target. This may be because the portion where the forming strain is concentrated is not in the openings but is positioned in the parts where the support and the conductive film is bonded to each other.

Meanwhile, it was confirmed that the forming strain is concentrated to the regions R12 and R13 in a case of performing the forming into a square tube shape by using the deep drawing process, and as in Examples 3 and 4, when the conductive film including the openings formed by cutout of portions corresponding to at least both of the regions R12 and R13 is used, the peeling of the support and the conductive film is prevented. Only the regions R12 and R13 may be set as openings as in Example 3, or all of the regions R11, R12, and R13 may be set as openings as in Example 4.

With respect to this, as in Comparative Examples 5 to 8, in a case of using the conductive film including the openings formed by cutout of a portion corresponding to only the region R11, only the region R12, only the region R13, or the regions R11 and R12 was used, peeling was recognized in some samples or all of the samples of the test target. This may be because the portion where the forming strain is concentrated is not in the openings but is positioned in the parts where the support and the conductive film is bonded to each other.

A conductive film laminate for a touch panel 23 manufactured by bonding a transparent conductive film 22 onto a surface of a transparent insulating support 21 with an adhesive was press-formed to have a cylindrical shape shown in FIG. 21. The conductive film laminate for a touch panel 23 includes a formed portion 23a which is formed into a cylindrical shape due to the press forming and a flange portion 23b which is on the periphery of the formed portion 23a.

Here, when some boundary lines 26 and 27 disposed at the same position are set in an annular boundary portion between an upper surface 24 and a side surface 25 of a cylinder of the formed portion 23a and an annular boundary portion between the side surface 25 of the cylinder and the flange portion 23b, a region of the upper surface 24 adjacent to the boundary line 26 is referred to as R21, a region of the side surface 25 of the cylinder interposed between the boundary line 26 and the boundary line 27 is referred to as R22, and a region of the flange portion 23b adjacent to the boundary line 27 is referred to as R23.

As shown in Examples 5 to 9 and Comparative Examples 9 to 15 below, a plurality of conductive film laminates for a touch panel in which conductive films including openings formed by cutout of a portion corresponding to at least one region of the regions R21, R22, and R23 were bonded to a support, were manufactured and respectively formed to have a cylindrical shape using the bulging process and the deep drawing process, and a peeling test for the conductive films from the supports was performed.

### Example 5

A conductive film laminate for a touch panel was manufactured in the same manner as in Example 1, except for using a conductive film including openings formed by cutout of regions R21 and R22 corresponding to four regions along the circumference of the cylinder, respectively, when performing the forming into a cylindrical shape, and the conductive film laminate for a touch panel was formed to have a cylindrical shape by using the bulging process.

In the same manner as in Example 1, a biaxial stretching polyethylene terephthalate (PET) film having a thickness of 100 μm was used as the conductive film, polycarbonate (PC) having a thickness 500 μm was used as the support, and a conductive film laminate for a touch panel was manufactured by bonding the conductive film to the support using an optically clear adhesive sheet (OCA) 8172CL manufactured by 3M. This conductive film laminate for a touch panel was formed to have a cylindrical shape having a size with a diameter of 70 mm and a height of 10 mm by using the bulging process.

### Example 6

A conductive film laminate for a touch panel was manufactured in the same manner as in Example 5, except for using a conductive film including openings formed by cutout of regions R22 and R23 corresponding to four regions along the circumference of the cylinder, respectively, when performing the forming into a cylindrical shape, and the conductive film laminate for a touch panel was formed to have a cylindrical shape by using the bulging process.

### Example 7

A conductive film laminate for a touch panel was manufactured in the same manner as in Example 5, except for using a conductive film including openings formed by cutout of regions R21, R22, and R23 corresponding to four regions along the circumference of the cylinder, respectively, when performing the forming into a cylindrical shape, and the conductive film laminate for a touch panel was formed to have a cylindrical shape by using the bulging process.

### Example 8

A conductive film laminate for a touch panel was manufactured in the same manner as in Example 5, except for using a conductive film including openings formed by cutout of regions R22 and R23 corresponding to four regions along the circumference of the cylinder, respectively, when performing the forming into a cylindrical shape, and the conductive film laminate for a touch panel was formed to have a cylindrical shape by using the deep drawing process.

### Example 9

A conductive film laminate for a touch panel was manufactured in the same manner as in Example 5, except for using a conductive film including openings formed by cutout of regions R21, R22 and R23 corresponding to four regions along the circumference of the cylinder, respectively, when performing the forming into a cylindrical shape, and the conductive film laminate for a touch panel was formed to have a cylindrical shape by using the deep drawing process.

### Comparative Example 9

A conductive film laminate for a touch panel was manufactured in the same manner as in Example 5, except for using a conductive film including openings formed by cutout of regions R21's corresponding to four regions along the circumference of the cylinder, respectively, when performing the forming into a cylindrical shape, and the conductive film laminate for a touch panel was formed to have a cylindrical shape by using the bulging process.

### Comparative Example 10

A conductive film laminate for a touch panel was manufactured in the same manner as in Example 5, except for using a conductive film including openings formed by cutout of regions R22's corresponding to four regions along the circumference of the cylinder, respectively, when performing the forming into a cylindrical shape, and the conductive film laminate for a touch panel was formed to have a cylindrical shape by using the bulging process.

### Comparative Example 11

A conductive film laminate for a touch panel was manufactured in the same manner as in Example 5, except for using a conductive film including openings formed by cutout of regions R23's corresponding to four regions along the circumference of the cylinder, respectively, when performing the forming into a cylindrical shape, and the conductive film laminate for a touch panel was formed to have a cylindrical shape by using the bulging process.

### Comparative Example 12

A conductive film laminate for a touch panel was manufactured in the same manner as in Example 5, except for using a conductive film including openings formed by cutout of regions R21's corresponding to four regions along the circumference of the cylinder, respectively, when performing the forming into a cylindrical shape, and the conductive film laminate for a touch panel was formed to have a cylindrical shape by deep drawing process.

### Comparative Example 13

A conductive film laminate for a touch panel was manufactured in the same manner as in Example 5, except for using a conductive film including openings formed by cutout of regions R22's corresponding to four regions along the circumference of the cylinder, respectively, when performing the forming into a cylindrical shape, and the conductive film laminate for a touch panel was formed to have a cylindrical shape by deep drawing process.

### Comparative Example 14

A conductive film laminate for a touch panel was manufactured in the same manner as in Example 5, except for using a conductive film including openings formed by cutout of regions R23's corresponding to four regions along the circumference of the cylinder, respectively, when performing the forming into a cylindrical shape, and the conductive film laminate for a touch panel was formed to have a cylindrical shape by deep drawing process.

### Comparative Example 15

A conductive film laminate for a touch panel was manufactured in the same manner as in Example 5, except for using a conductive film including openings formed by cutout of regions R21 and R22 corresponding to four regions along the circumference of the cylinder, respectively, when performing the forming into a cylindrical shape, and the conductive film laminate for a touch panel was formed to have a cylindrical shape by deep drawing process.

5 samples of the conductive film laminates for a touch panel were manufactured and formed to have a cylindrical shape in Examples 5 to 9 and Comparative Examples 9 to 15 and the peeling of the support and the conductive films regarding the samples was visually evaluated. The results shown in Table 2 were obtained.

TABLE 2

| | Molded | Forming | | Evaluation |
|---|---|---|---|---|
| | shape | method | Opening | results |
| Example 5 | Cylinder | Bulging | R21 + R22 | A |
| Example 6 | Cylinder | Bulging | R22 + R23 | A |
| Example 7 | Cylinder | Bulging | R21 + R22 + R23 | A |
| Example 8 | Cylinder | Deep drawing | R22 + R23 | A |
| Example 9 | Cylinder | Deep drawing | R21 + R22 + R23 | A |
| Comparative | Cylinder | Bulging | R21 | B |
| Example 9 | | | | |
| Comparative | Cylinder | Bulging | R22 | B |
| Example 10 | | | | |
| Comparative | Cylinder | Bulging | R23 | C |
| Example 11 | | | | |
| Comparative | Cylinder | Deep drawing | R21 | C |
| Example 12 | | | | |
| Comparative | Cylinder | Deep drawing | R22 | C |
| Example 13 | | | | |
| Comparative | Cylinder | Deep drawing | R23 | B |
| Example 14 | | | | |
| Comparative | Cylinder | Deep drawing | R21 + R22 | C |
| Example 15 | | | | |

In the evaluation results of Table 2, A indicates that peeling is not recognized in all samples of a test target, B indicates that peeling is recognized in some samples of a test target, and C indicates that peeling is recognized in all samples of a test target.

It was confirmed from Table 2, that the forming strain is concentrated to the regions R21 and R22 or the regions R22 and R23 in a case of performing the forming into a cylindrical shape by using the bulging process, and as in Examples 5 to 7, when the conductive film including the openings formed by cutout of portions corresponding to at least both of the regions R21 and R22 or both of the regions R22 and R23 is used, the peeling of the support and the conductive film is prevented. As in Example 7, all of the regions R21, R22, and R23 may be set as openings.

With respect to this, as in Comparative Examples 9 to 11, in a case of using the conductive film including the openings formed by cutout of a portion corresponding to only the region R21, only the region R22, or only the region R23 was used, peeling was recognized in some samples or all of the samples of the test target. This may be because the portion where the forming strain is concentrated is not in the openings but is positioned in the parts where the support and the conductive film is bonded to each other.

Meanwhile, it was confirmed that the forming strain is concentrated to the regions R22 and R23 in a case of performing the forming into a cylindrical shape by using the deep drawing process, and as in Examples 8 and 9, when the conductive film including the openings formed by cutout of portions corresponding to at least both of the regions R22 and R23 is used, the peeling of the support and the conductive film is prevented. Only the regions R22 and R23 may be set as openings as in Example 8, or all of the regions R21, R22, and R23 may be set as openings as in Example 9.

With respect to this, as in Comparative Examples 12 to 15, in a case of using the conductive film including the openings formed by cutout of a portion corresponding to only the region R21, only the region R22, only the region R23, or the regions R21 and R22 was used, peeling was recognized in some samples or all of the samples of the test target. This may be because the portion where the forming strain is concentrated is not in the openings but is positioned in the parts where the support and the conductive film is bonded to each other.

### EXPLANATION OF REFERENCES

1, 21, 32, 52, 62, 72: support
2, 22, 33, 53, 63, 73: conductive film
3, 23, 31, 51, 61, 71: conductive film laminate for touch panel
3a, 23a, 51a, 61a, 71a: formed portion
3b, 23b, 51b, 61b, 71b: flange portion
4: spring
5: blank holder
6: lower die
7: upper die
11, 24, 42, 57, 65, 75: upper surface
12: side
13, 25, 44, 55, 66, 76: side surface
14, 58: apex
15: intersection point
26, 27, 67, 68, 77, 78: boundary line
34, 54, 64, 74: opening
35: insulating substrate
36: conductive member
37: protective layer
38: first detection electrode
38a, 40a: thin metal wire
39: first peripheral wiring
40: second detection electrode
41: second peripheral wiring
43: apex
45, 59, 69, 79: touch panel
56: intersection point
L1, L2: measurement line
P0 to P3: measurement point
R11 to R13, R21 to R23: region
S1: sensing area
S2: peripheral area
D1: first direction
D2: second direction

1. A conductive film laminate for forming a three-dimensional conductor, comprising:
an insulating support having a flat plate shape; and
a conductive film which is bonded onto a surface of the support with an adhesive,
wherein the conductive film includes an insulating substrate having flexibility and a conductive layer which is disposed on a surface of the insulating substrate, and
the insulating substrate includes at least one opening formed by cutout of a portion where forming strain is concentrated, when forming the conductor, and the opening is covered with the support.

2. The conductive film laminate according to claim 1,
wherein, when forming the conductor, in a case where a formed portion which is formed into a three-dimensional shape and a flange portion which is on a periphery of the formed portion are formed, and the formed portion includes an upper surface and at least one side surface connected to the upper surface, the opening of the conductive film is disposed so as to include a part of a boundary portion between the upper surface and the side surface of the formed portion.

3. The conductive film laminate according to claim 2,
wherein the formed portion includes the upper surface which is polygonal and a plurality of the side surfaces,
the conductive film includes a plurality of the openings corresponding to a plurality of apexes of the upper surface, and
each opening is disposed so as to include the apex corresponding to the upper surface and a pair of the side surfaces which intersect with each other at the corresponding apex.

4. The conductive film laminate according to claim 2,
wherein the formed portion includes the upper surface which is circular or elliptical and one side surface,
the conductive film includes a plurality of the openings corresponding to boundary lines on a plurality of portions of an annular boundary portion between the upper surface and the side surface, and
each opening is disposed so as to include the boundary line corresponding to the upper surface and the side surface.

5. The conductive film laminate according to claim 2,
wherein the opening is formed of a penetration hole.

6. The conductive film laminate according to claim 3,
wherein the opening is formed of a penetration hole.

7. The conductive film laminate according to claim 4,
wherein the opening is formed of a penetration hole.

8. The conductive film laminate according to claim 2,
wherein the forming is a bulging process.

9. The conductive film laminate according to claim 1,
wherein, when forming the conductor, the a formed portion which is formed into a three-dimensional shape and a flange portion which is on a periphery of the formed portion are formed, and the formed portion includes an upper surface and at least one side surface connected to the upper surface, and
the opening of the conductive film is disposed so as to include a part of a boundary portion between the side surface of the formed portion and the flange portion.

10. The conductive film laminate according to claim 9,
wherein the formed portion includes the upper surface which is polygonal and a plurality of the side surfaces,
the conductive film includes the plurality of openings corresponding to a plurality of intersection points where a pair of the side surfaces of the formed portion adjacent to each other and the flange portion intersect with each other, and
each opening is disposed so as to include the intersection points corresponding to the pair of side surfaces of the formed portion and the flange portion which intersect with each other in the corresponding intersection point.

11. The conductive film laminate according to claim 9,
wherein the formed portion includes the upper surface which is circular or elliptical and one side surface,
the conductive film includes a plurality of the openings corresponding to boundary lines on a plurality of portions of an annular boundary portion between the side surface and the flange portion, and
each opening is disposed so as to include the boundary line corresponding to the side surface of the formed portion and the flange portion.

12. The conductive film laminate according to claim 9,
wherein the opening is formed of a cut-out.

13. The conductive film laminate according to claim 10,
wherein the opening is formed of a cut-out.

14. The conductive film laminate according to claim 11,
wherein the opening is formed of a cut-out.

15. The conductive film laminate according to claim 9,
wherein the forming is a deep drawing process.

16. The conductive film laminate according to claim 1,
wherein the support and the insulating substrate have transparency,
the conductive layer includes a plurality of detection electrodes which are disposed on at least one surface of the insulating substrate and has a mesh pattern formed of thin metal wires, and
the conductive film laminate is used in a touch panel.

17. A conductor in which the conductive film laminate according to claim 1 is formed to have a three-dimensional shape.

18. A manufacturing method of a conductor comprising:
performing press forming of a conductive film laminate into a three-dimensional shape; and
removing an unnecessary portion of the press-formed conductive film laminate,
wherein the conductive film laminate includes an insulating support having a flat plate shape; and a conductive film which is bonded onto a surface of the support with an adhesive,
wherein the conductive film includes an insulating substrate having flexibility and a conductive layer which is disposed on a surface of the insulating substrate, and
the insulating substrate includes at least one opening formed by cutout of a portion where forming strain is concentrated, when forming the conductor, and the opening is covered with the support.

19. The manufacturing method of a conductor according to claim 18, further comprising:
performing bulging of the conductive film laminate into a three-dimensional shape; and
removing a flange portion of the conductive film laminate subjected to the bulging as an unnecessary portion,
wherein in a case where a formed portion which is formed into the three-dimensional shape and the flange portion which is on a periphery of the formed portion are formed, and the formed portion includes an upper surface and at least one side surface connected to the upper surface, the opening of the conductive film is disposed so as to include a part of a boundary portion between the upper surface and the side surface of the formed portion.

20. The manufacturing method of a conductor according to claim 18, further comprising:
performing deep drawing of the conductive film laminate into a three-dimensional shape; and
removing a flange portion of the conductive film laminate subjected to the deep drawing as an unnecessary portion,
wherein, when forming the conductor, a formed portion which is formed into the three-dimensional shape and the flange portion which is on a periphery of the formed portion are formed, and the formed portion includes an upper surface and at least one side surface connected to the upper surface, and the opening of the conductive film is disposed so as to include a part of a boundary portion between the side surface of the formed portion and the flange portion.
